(19) United States
(12) Patent Application Publication
(10) Pub. No.: US 2024/0183469 A1
(43) Pub. Date: Jun. 6, 2024

(54) VALVE

(71) Applicant: MATSUIKIKI INDUSTRIES CO., LTD., Nagahama-shi (JP)

(72) Inventors: Sadanori MATSUI, Nagahama-shi (JP); Takashi KITAGAWA, Nagahama-shi (JP); Yukikazu TERADA, Nagahama-shi (JP)

(21) Appl. No.: 18/061,970

(22) Filed: Dec. 5, 2022

(51) Int. Cl. F16L 19/02; F16K 11/22

(52) U.S. Cl. CPC F16L 19/0206; F16K 11/22; F16L 19/0237

(57) ABSTRACT

A valve including a main body which includes a fluid passage, a first port connected to the fluid passage, a second port connected to the fluid passage, and a first groove formed on an outer circumference of the main body at the first port. The first groove including a lower wall, and an upper wall including an inclined surface which extends away from the lower wall as the upper wall extends radially outward, the inclined surface being located on a radially outer portion of the upper wall. The valve further including a connection member attached to the first port, the connection member including a second groove on a radially inner surface of the connection member, and a retaining member disposed in the first groove and the second groove.

### BACKGROUND

### 1. Field

The present invention relates to a fitting having an improved connection member. In particular, the present invention relates to a valve having an improved connection nut.

### 2. Description of Related Art

A conventional isolation valve includes three fluid flow ports. The second and third fluid flow ports each include a ball valve to allow the respective port to be opened or closed, while the first fluid flow port does not include a ball valve. Normally, the first port includes a rotating connector, such as a threaded connection nut, which allows the isolation valve to be attached at the first port without rotation of the isolation valve main body.

Isolation valves are used with tankless water heaters to isolate the water heater from the input and output water feeds so as to allow the system to be drained and flushed during cleaning. A tankless water heater system will normally include a water input and a hot water output. A first isolation valve is located upstream of the tankless water heater to connect the water heater to the water source and a second isolation valve is located downstream from the tankless water heater to connect the water heater to the water destination.

In the first isolation valve, the third port is attached to the water source and includes a ball valve, the first port is attached to the input of the water heater, and the second port acts as a bypass and includes a ball valve. In the second isolation valve, the third port is attached to the water destination and includes a ball valve, the first port is attached to the hot water output of the water heater, and the second port acts as a bypass and includes a ball valve.

During normal operation, in the first isolation valve, the ball valve attached to the third port is open to allow water to flow from a water source to the water heater, while the ball valve for the second port bypass is closed. Similarly, in the second isolation valve, the ball valve attached to the third port is open to allow water to flow from the water heater to the water destination, while the ball valve for the second port bypass is closed.

During a cleaning operation, in the first isolation valve, the ball valve attached to the third port is closed to isolate the water heater from the water source and the ball valve for the bypass is opened. Similarly, in the second isolation valve, the ball valve attached to the third port is closed to isolate the water heater from the water destination and the ball valve for the second port bypass is opened. When the ball valves of the second ports are opened on the two isolation valves, the fluid contained in the water heater is drained. A flushing system can then be attached to the second bypass ports and cleaning fluid can be circulated through the water heater. This allows the tankless water heater to be cleaned, such as the removal of scaling in the tankless water heating system caused by, for example, minerals in the water.

### SUMMARY

This Summary is provided to introduce a selection of concepts in a simplified form that are further described in the Detailed Description. This Summary is not intended to identify key or essential features of the claimed subject matter, nor is it intended to be used as an aid in determining the scope of the claimed subject matter.

### Technical Problem

In an isolation valve, the rotatable connection member is normally a threaded connection nut rotatably attached to the valve main body at the first port. This connection nut is used to connect the isolation valve to the water system. In particular, the connection nut is used to connect the first port of the valve to the tankless water heater.

When the isolation valve is manufactured, the connection nut is attached to the valve main body through use of a retaining member, such as a C-ring, which rests in a first groove in the valve main body and a second groove located in the connection nut. During assembly of the isolation valve, the C-ring is compressed into the first groove, the first groove having a depth sufficient to completely accommodate the C-ring when the C-ring is compressed. While the C-ring is in a compressed state the connection nut is slid over the first groove so that the first and second grooves align. Once the first and second grooves align, the C-ring springs back into a less compressed state so as to be partially disposed in both the first groove and the second groove. The C-ring, now located in both grooves, keeps the connection nut secured to the valve main body in a state in which the connection nut can be rotated around its central axis.

When the valve is installed, the connection nut is threaded onto the fitting leading to the tankless water heater. To prevent potential leaks, the connection nut is tightened to a specified torque. The connection nut is also subject to vibration and impact forces (such as from a water hammer effect) during normal operation. These forces result in the connection nut being urged upward in the axial direction of the connection nut relative to the valve main body.

As shown in FIG. 8A, when the center point of the cross section of the C-ring is located at the junction between the connection nut and the valve main body, the forces applied to the C-ring are in the axial direction of the connection nut and there is essentially no force applied in the radial direction.

However, the C-ring has a circular cross-sectional shape, if the C-ring or the connection nut are shifted so that the center of the C-ring cross section is located further into the first groove in the valve main body, as shown in FIG. 8B, then the bottom edge of the second groove contacts a point on the C-ring which is radially outward of a center of the cross-section of the C-ring. This applies a force having a component in the radial direction of the C-ring cross section to the C-ring. This force can push the C-ring further into the first groove so that the C-ring no longer provides a counter force against the force urging the connection nut in the upward Y-direction relative to the valve main body. That is, when a sufficient amount of the C-ring is pressed into the first groove due to the radially inwardly directed force, the C-ring no longer stops the connection nut from moving relative to valve main body in the axial direction. This can allow the connection nut to slip off of the valve main body which can result in first fluid flow port of the valve leaking or detaching from the water system.

While dislocation of the C-ring can occur, as described above, under a variety of situations, it is especially likely when a large amount of axial force or torque is applied to the connection nut, such as when the connection nut is being tightened.

For example, during installation the isolation valve is connected to a corresponding point in the water system with the connection nut, which is then threaded on and tightened, preferably to a set amount of torque to ensure proper sealing and operation. However, when the connection nut has a certain level of torque applied, the C-ring may be pressed inward due to the force applied to it by the connection nut.

### Solution to Problem

In view of the above, it is desirable to provide a system which prevents biasing of the C-ring in the radially inward direction when an axial force is applied by the connection nut to the C-ring.

A valve according to one aspect includes a main body which includes a fluid passage, a first port connected to the fluid passage, a second port connected to the fluid passage, and a first groove formed on an outer circumference of the main body at the first port. The first groove includes a lower wall, and an upper wall including an inclined surface which extends away from the lower wall as the upper wall extends radially outward, the inclined surface being located on a radially outer portion of the upper wall. The valve further includes a connection member attached to the first port, the connection member including a second groove on a radially inner surface of the connection member, and a retaining member disposed in the first groove and the second groove.

Another exemplary aspect of the invention is a valve where the first groove has a depth which is greater than or equal to a cross-sectional width of the retaining member.

Another exemplary aspect of the invention is a valve where the inclined surface is configured so as to apply a reaction force in the radial direction to the retaining member when the retaining member is pressed against the inclined surface in the axial direction.

Another exemplary aspect of the invention is a valve where the inclined surface is configured so as to contact a radially inner portion of the retaining member.

Another exemplary aspect of the invention is a valve where a depth of the second groove plus a width of the inclined surface, in the radial direction, is greater than half a cross-sectional width of the retaining member.

Another exemplary aspect of the invention is a valve where the second groove has a depth approximately equal to half a cross-sectional width of the retaining member.

Another exemplary aspect of the invention is a valve where the retaining member is a C-ring.

Another exemplary aspect of the invention is a valve where the connection member is rotatable around a center axis of the connection member.

Another exemplary aspect of the invention is a valve where the connection member is a threaded connection nut.

Another exemplary aspect of the invention is a valve where the second port includes a second port ball valve.

Another exemplary aspect of the invention is a valve where the main body includes a third port.

Another exemplary aspect of the invention is a valve where the third port includes a third port ball valve.

Another exemplary aspect of the invention is a valve where the retaining member has a circular cross-section.

A valve according to another aspect of the invention includes a main body including a fluid passage, a first port connected to the fluid passage, a second port connected to the fluid passage, the second port including a second port ball valve, and a first groove formed on an outer circumference of the main body at the first port. The first groove includes a lower wall, and an upper wall including an inclined surface which extends away from the lower wall as the upper wall extends radially outward, the inclined surface being located on a radially outer portion of the upper wall. The valve further includes a connection member attached to the first port, the connection member including a second groove on a radially inner surface of the connection member, and a retaining member disposed in the first groove and the second groove.

A fitting according to another aspect of the invention includes a main body including a fluid passage, a first port connected to the fluid passage, a second port connected to the fluid passage, and a first groove formed on an outer circumference of the main body at the first port. The first groove includes a lower wall, and an upper wall including an inclined surface which extends away from the lower wall as the upper wall extends radially outward. The fitting further includes a connection member attached to the first port, the connection member including a second groove on a radially inner surface of the connection member, and a retaining member disposed in the first groove and the second groove.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates a side view of an embodiment of the valve;

FIG. 2A illustrates a cross-section view of the valve of FIG. 1;

FIG. 2B illustrates a cross-section of a portion of the valve main body;

FIG. 3 illustrates a plan view of the C-ring;

FIG. 4 illustrates a cross-section of a section of the C-ring;

FIG. 5 illustrates an enlarged cross-section view of the first port area of the valve;

FIG. 6 illustrates a cross-section view of a portion of the valve connected to a fluid system;

FIG. 7 illustrates a schematic of the C-ring in the first and second groove under load;

FIG. 8A illustrates a schematic of a comparative example of a C-ring in a first and second groove under load; and

FIG. 8B illustrates a schematic of a comparative example of a shifted C-ring in a first and second groove under load.

### DETAILED DESCRIPTION

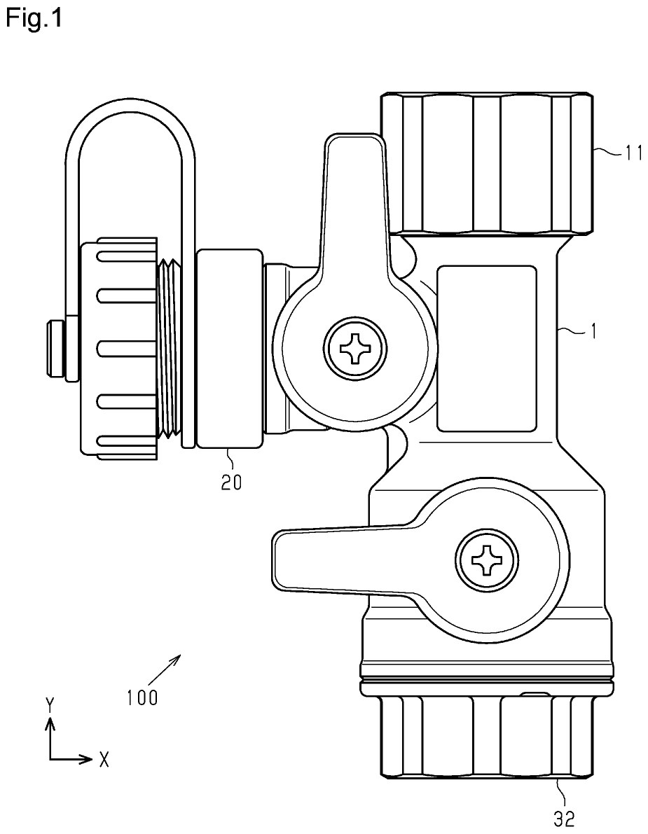

Referring now to the drawings, and more particularly to FIGS. 1-8B, there are shown exemplary embodiments of the method and structures according to the present invention.

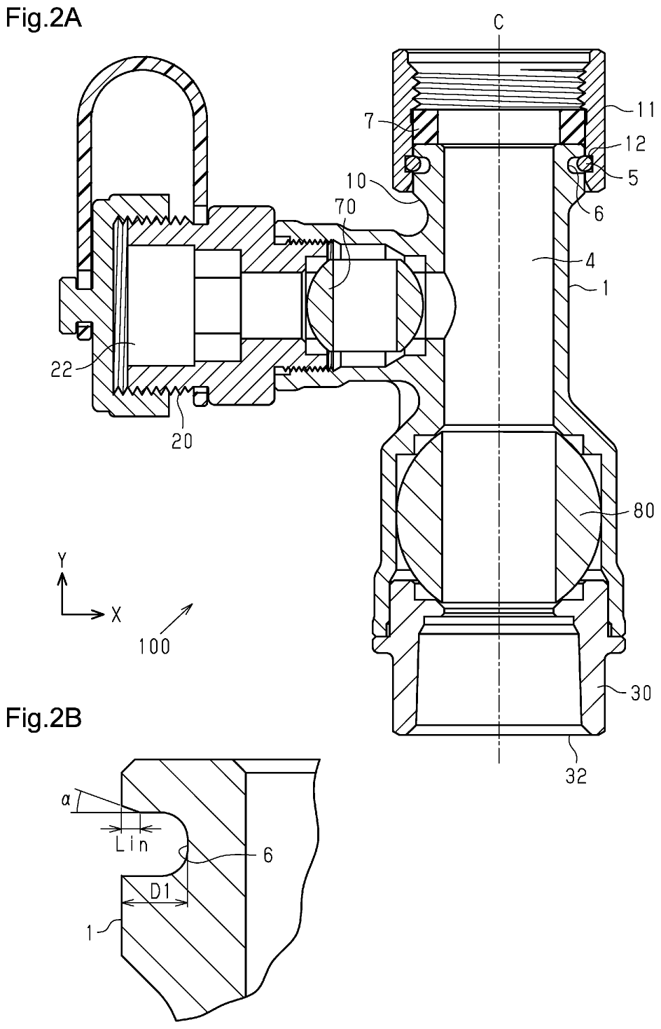

In an exemplary embodiment, as illustrated in FIGS. 1 and 2A, isolation valve 100 includes a valve main body 1 having a first port 10, a second port 20 and a third port 30, each of the three ports connecting to the valve main fluid passage 4.

Second port 20 is formed on a side of the valve main body 1 so as to face in a direction orthogonal to the directions faced by first port 10 and third port 30. Second port 20 includes an externally threaded section and a removeable cap. The externally threaded section allows an attachment, such as the hose of a cleaning unit, to be attached to second port 20. Second port 20 includes a ball valve 70. The ball valve 70 connects the second port opening 22 to the fluid passage 4.

The third port 30 has a threaded portion (threads not shown) which is fixed relative to the valve main body 1. The third port 30 also includes a ball valve 80. The ball valve 80 connects the third port opening 32 to the main fluid passage 4.

The first port 10 has a connection member, for example threaded connection nut 11. Connection nut 11 is rotatable relative to the valve main body 1. In other words, the connection nut 11 is attached to the valve main body 1 so as to be rotatable. This allows the first port 10 to be screwed onto a fitting or threaded pipe without requiring rotation of the valve main body 1. Preferably, the connection nut 11 and the first port 10 have a common central axis C when the valve main body 1 is in the assembled state. This common central axis C extends in the axial direction.

The connection nut 11 includes a sealing member, for example gasket 7. Gasket 7 has a larger outer diameter than an inner diameter of the connection nut 11. This allows gasket 7 to be firmly secured in connection nut 11 after installation so as to prevent gasket 7 from being dislodged from the connection nut 11. In one example, the outer diameter of gasket 7 may be greater than the inner diameter of the threads of connection nut 11 and may reside in a recess in the connection nut 11 which is formed below the threads in the axial direction.

The connection nut 11 may be rotatably fixed to the valve main body 1 through the use of a retaining member, for example C-ring 5. Valve main body 1 includes a first groove 6 formed adjacent to the opening of first port 10. Connection nut 11 includes a second groove 12, formed on an inner surface of the connection nut 11 and located so as to align with the first groove 6 in an axial direction of the first port 10 when the connection nut 11 and the valve main body 1 are in an assembled state.

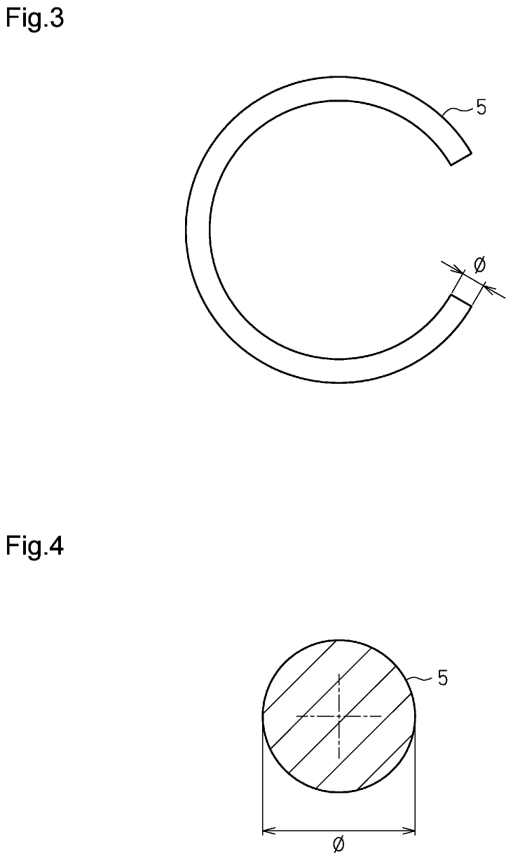

FIGS. 3 and 4 illustrate the C-ring 5. C-ring 5 has a circular arc shape. That is, C-ring 5 is C-shaped. C-ring 5 has a circular cross-section, therefore the diameter Φ of C-ring 5 illustrated in FIG. 4 is also the cross-sectional width of C-ring 5 in this embodiment. The center of the circular cross-section of C-ring 5 is illustrated with a long-short dashed cross, for example as shown in FIG. 4.

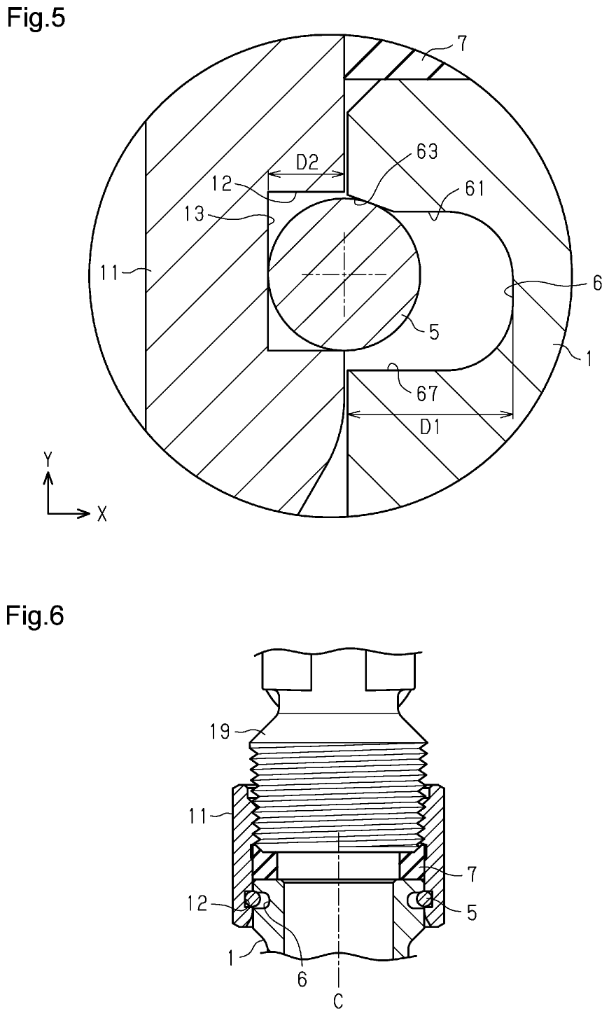

As shown in FIG. 5, first groove 6 has a depth D1 which is greater than or equal to the diameter Φ of C-ring 5. Second groove 12 has a depth D2, in the radial direction of the connection nut 11, which is less than a diameter Φ of the cross-section of C-ring 5. That is, second groove 12 has a depth D2 which is less than the cross-sectional width of C-ring 5. For example, the depth D2 may be not less than one half of the diameter Φ or may be slightly greater than one half of the diameter Φ.

The upper wall 61 of groove 6 has an inclined surface 63 such that the diameter of the inclined surface 63 increase as it approaches the first port 10. That is, the inclined surface 63 is angled such that the distance between the upper wall 61 and the lower wall 67 increases as the inclined surface extends radially outward from a central axis C of the first port 10.

In general, in a C-ring 5 with a round cross-section, the groove 12 and C-ring 5 should be sized so that the inclined surface 63 contacts the C-ring 5 at a point radially inward (e.g., positive X-direction in FIG. 5) of the center of the cross section of the C-ring 5. In one embodiment, as shown in FIGS. 5 and 2B, the angle α of the inclined surface 63 is approximately twenty degrees and the inclined surface 63 extends, in the radial direction of groove 6, less than one half the value of the diameter Φ.

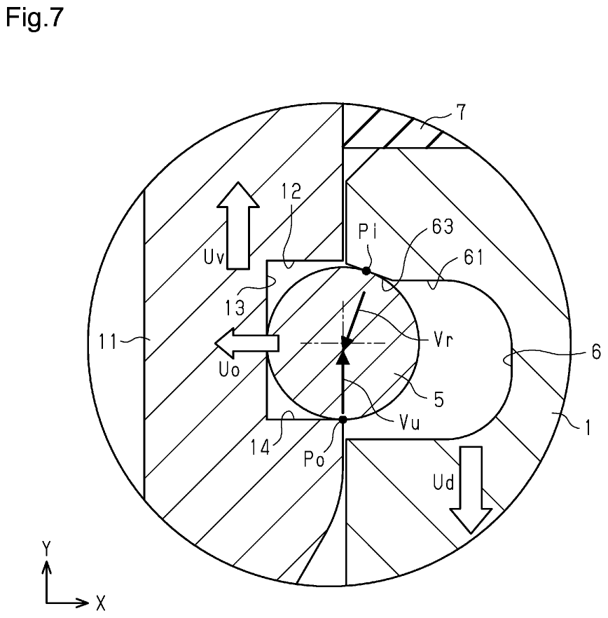

FIG. 6 illustrates the connection nut 11 when attached to a fluid system, such as a tankless water heater. Connection nut 11 is threaded onto a threaded male connection portion 19. In this example, connection nut 11 is tightened with a certain amount of torque until connection nut 11 is firmly secured to the connection portion 19. This process deforms gasket 7, so as to seal the connection.

As shown in FIG. 7, when subjected to a load, such as when the connection nut 11 is attached to a water system and tightened, a force Uv in the positive Y-axis direction is applied to connection nut 11, while a force Ud in the negative Y-axis direction is applied to the valve main body 1. When the connection nut 11 is urged in the positive Y-axis direction, that is in the upward direction of FIG. 7, a bottom portion Po of the C-ring 5 is pressed upward in the direction Vu by the bottom wall 14 of groove 12 of the connection nut 11. In response, pressure is applied by the inclined surface 63 at the radially inward top portion of the C-ring 5, indicated as Pi, which presses the C-ring 5 downward and radially outward in the direction Vr. The radially outward component of the force Vr urges the C-ring 5 radially outward toward back wall 13 of groove 12, as illustrated with arrow Uo. This outward pressure is generated on multiple areas around the arc of C-ring 5 so as to ensure the radius of C-ring 5 is increased, or at least prevented from being decreased, by elastic deformation.

This outward pressure also prevents the C-ring 5 from otherwise moving too far into groove 6. This ensures that a portion of C-ring 5 remains in groove 12, which prevents connection nut 11 from detaching from valve main body 1.

The inclined surface 63 is provided around an entirety of the circumference of groove 6. This allows the outward pressure on the C-ring 5 to be provided uniformly thereto. The radially outward pressure provided along the length of the C-ring 5 ensures that the C-ring 5 stays in an expanded and open state, and from otherwise being moved fully into groove 6, which in turn allows the C-ring 5 to be positioned to resist movement of the connection nut 11 in the Y-axis direction so as to keep the connection nut 11 in the proper position. This prevents the connection nut 11 from detaching from valve main body 1.

Advantages associated with the exemplary embodiments of the invention will now be described.

When the connection nut 11 is under a load in the axial direction, for example through a tightening of the connection nut 11, a vibration, or an impact to the system, the connection nut 11 urges the C-ring 5 upward into the inclined surface 63. When the C-ring 5 presses upward into inclined surface 63, the inclined surface urges the C-ring 5 radially outward into groove 12. This prevents C-ring 5 from being pressed too far into groove 6, which could result in the connection nut 11 being detached from the valve main body 1.

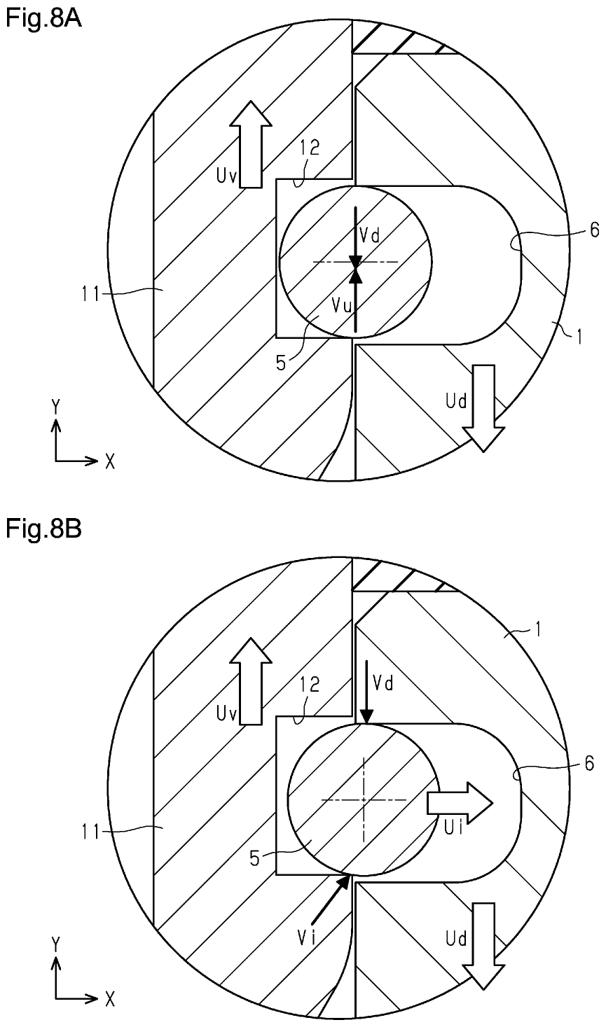

A further advantage is that grooves 6 and 12, and C-ring 5 may have larger manufacturing tolerances. That is, in a comparative example where inclined surface 63 is not present, as shown in FIG. 8A, if the groove 12 and C-ring 5 align properly, then the center point of the cross-section of C-ring 5 contacts both the top and bottom edges of grooves 6 and 12, respectively. This produces forces Vd and Vu on C-ring 5 with only Y-components. However, as shown in FIG. 8B, if the C-ring 5 is deformed or shifted due to an axial force, as described previously, or if the groove 12 is too shallow or if the C-ring 5 has too large of a cross-sectional width/diameter, or if the C-ring 5 is otherwise shaped in a way in which the center of the cross-section thereof is inward of the bottom wall of groove 12, then when the connection nut 11 presses upward on C-ring 5, a force Vi, with components in the vertical and radially inward direction (e.g., positive Y-axis and positive X-axis direction in FIG. 8B), is imparted on C-ring 5 from the edge of the bottom wall of groove 12. This urges the C-ring in the direction of Ui, into groove 6. This can press the C-ring 5 into groove 6 far enough that C-ring 5 no longer stops the connection nut 11 from sliding relative to the valve main body 1.

As can be seen in FIG. 7, the inclined surface 63 allows for minor imperfections in the size and positioning of the grooves 6 and 12 and C-ring 5, while still imparting a radially outward force on C-ring 5. That is, the inclined surface 63 increases the allowable contact location, between the inward/upper surface of the C-ring and the upper surface of groove 6, radially inward based on the shape and depth of the inclined surface 63.

### Modifications

While the invention has been described using particular embodiments, the invention is not limited to those embodiments. The features of the different embodiments may be combined as long as the combined features are technically compatible with each other.

That is, ball valves 70 and 80 may be replaced with some other openable and closable valve system. Also, the valve may be of a type other than an isolation valve.

Furthermore, the valve is not limited to valves for controlling the flow of water. For example, the valve may be a hydraulic valve, a pneumatic valve, etc.

While the improved connection member has been described with respect to a valve, the improved connection member may be applied to any rotatable connection member utilizing a C-ring. For example, the invention may be applied to a fluid fitting which does not include a valve.

While the attachment member in the above embodiments is a C-ring, any attachment member may be used which can be disposed in grooves 6 and 12 to stop movement of the connection nut 11 in the Y-direction.

While the inclined surface 63 is illustrated as having a flat slope, it is not limited to this design. That is, inclined surface 63 may be a curved surface, a tapered surface, a polygonal surface, or any other geometry which will impart a force at least partially in the X-direction to the C-ring 5, when a force urges the C-ring 5 in the Y-direction against the inclined surface 63. Similarly, the cross-sectional shape and size of the C-ring 5 can be altered as long as the interface between the inclined surface 63 and the C-ring 5 causes a force in the radially outward direction when an axial force is applied to the C-ring 5 in the desired direction by the connection nut 11.

While the inclined surface 63 has been described as being provided around an entirety of the radius of groove 6 in the above embodiment, the inclined surface 63 may be provided periodically around the radius of groove 6. That is, there may be one or more portions of groove 6 in which the inclined surface 63 is absent.

While the connection member is a threaded connection nut 11 in the above embodiment, the invention is not limited to this configuration. That is, the connection member may be any connection type which is secured by an attachment member located in a groove thereof which resists movement in the axial direction. The connection member may be rotatable around the central axis or non-rotatable.

While specific dimensions are mentioned with regard to some embodiments, the invention is not limited to any particular dimensions or angles and may be sized according to need.

Further, the materials from which the isolation valve are formed may be made of any suitable combination of materials. For example, the connection nut 11 and valve main body 1 may be made of different materials, such plastic for the connection nut 11 and brass for the valve main body 1.

While the invention has been described in terms of exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

1. A valve comprising:
a main body including:
a fluid passage;
a first port connected to the fluid passage;
a second port connected to the fluid passage; and
a first groove formed on an outer circumference of the main body at the first port, the first groove including:
a lower wall; and
an upper wall including an inclined surface which extends away from the lower wall as the upper wall extends radially outward, the inclined surface being located on a radially outer portion of the upper wall;
a connection member attached to the first port, the connection member including a second groove on a radially inner surface of the connection member; and
a retaining member disposed in the first groove and the second groove,
wherein the second port includes a second port valve, and
wherein a depth of the second groove is configured such the retaining member is able to contact the inclined surface while contacting a back wall of the second groove.

2. The valve according to claim 1, wherein the first groove has a depth which is greater than or equal to a cross-sectional width of the retaining member.

3. The valve according to claim 1, wherein the inclined surface is configured so as to apply a reaction force in the radial direction to the retaining member when the retaining member is pressed against the inclined surface in the axial direction.

4. The valve according to claim 3, wherein the inclined surface is configured so as to contact a radially inner portion of the retaining member.

5. The valve according to claim 1, wherein the depth of the second groove plus a width of the inclined surface, in the radial direction, is greater than half a cross-sectional width of the retaining member.

6. The valve according to claim 1, wherein the depth of the second groove is not less than half a cross-sectional width of the retaining member.

7. The valve according to claim 1, wherein the retaining member is a C-ring.

8. The valve according to claim 1, wherein the connection member is rotatable around a center axis of the connection member.

9. The valve according to claim 8, wherein the connection member is a threaded connection nut.

10. The valve according to claim 1, wherein the second port valve comprises a ball valve.

11. The valve according to claim 1, wherein the main body includes a third port.

12. The valve according to claim 11, wherein the third port includes a third port ball valve.

13. (canceled)

14. The valve according to claim 1, wherein the retaining member has a circular cross-section.

15. A valve comprising:
a main body including:
a fluid passage;
a first port connected to the fluid passage;
a second port connected to the fluid passage, the second port including a second port ball valve; and
a first groove formed on an outer circumference of the main body at the first port, the first groove including:
a lower wall; and
an upper wall including an inclined surface which extends away from the lower wall as the upper wall extends radially outward, the inclined surface being located on a radially outer portion of the upper wall;
a connection member attached to the first port, the connection member including a second groove on a radially inner surface of the connection member; and
a retaining member disposed in the first groove and the second groove,
wherein a depth of the second groove is configured such that the retaining member is able to contact the inclined surface while contacting a back wall of the second groove.

16. A fitting comprising:
a main body including:
a fluid passage;
a first port connected to the fluid passage;
a second port connected to the fluid passage; and
a first groove formed on an outer circumference of the main body at the first port, the first groove including:
a lower wall; and
an upper wall including an inclined surface which extends away from the lower wall as the upper wall extends radially outward;
a connection member attached to the first port, the connection member including a second groove on a radially inner surface of the connection member; and
a retaining member disposed in the first groove and the second groove,
wherein a depth second groove is configured such that the retaining member is able to contact the inclined surface while contacting a back wall of the second groove.

17. The valve according to claim 1, wherein the depth of the second groove is less than a cross-sectional width of the retaining member.

18. The valve according to claim 1, wherein the inclined surface and the second groove are configured such that when the inclined surface presses the retaining member radially outward, the retaining member is configured so as to abut against the back wall of the second groove.

19. The valve according to claim 1, wherein the depth of the second groove is less than a depth of the first groove.

20. The valve according to claim 1, wherein a depth of the first groove into the outer circumference of the main body in a radial direction is greater than a cross-sectional width of the retaining member.

21. The valve according to claim 1, wherein the back wall of the second groove is substantially parallel to a back wall of the first groove.
